(19) United States
(12) Patent Application Publication
(10) Pub. No.: US 2007/0023544 A1
(43) Pub. Date: Feb. 1, 2007

(54) Spray kit with conduit assembly

(76) Inventor: Alfred L. Woods, Bellfontaine, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/191,431

(22) Filed: Jul. 27, 2005

(51) Int. Cl. A62C 13/62; A01G 25/14

(52) U.S. Cl. 239/302; 239/375

(57) ABSTRACT

The present invention relates to a spray kit with a conduit assembly. The invention generally includes a container with an aperture, a hose passing through that aperture, a conduit assembly that resides at least partially in the container, and a spray device. At least a portion of the hose resides in the conduit assembly. In addition, the spray device fluidly communicates with the container via the hose.

### TECHNICAL FIELD

The present invention relates to spray-kits for dispensing fluids. More specifically, the present invention relates to a spray kit with a conduit assembly. In particular, the present invention relates to a spray kit with a conduit assembly that is adapted to be received in a fluid container.

### BACKGROUND ART

Consumers generally purchase painting kits for home or commercial use. By using a paint sprayer, a user can paint a surface faster than is possible with a brush or roller. Moreover, a paint sprayer generally provides just as good if not better surface coverage than a brush or roller.

Typically, spray kits include a spray device with a detachable fluid container. Other spray kits utilize a hose receivable in a fluid container. If the container is relatively large, then the user has access to a relatively large amount of paint and will rarely need to refill the container. Thus, a large container saves the user from constantly replenishing his or her paint supply. Furthermore, a relatively long hose will allow the user to reach greater distances and thus, such a hose saves the user from constantly moving a heavy, paint-filled container.

However, current spray kits are ineffective in several ways. First, the hose is not retained in the container. For example, the hose may fall out and cause paint to spill. Not only is the associated cleanup generally aggravating, but the user must spend additional money to purchase more paint. In addition to paint spills, the hose may coil while inside the container. This coiling may impair fluid flow and may disrupt paint application, causing uneven paint coverage. Furthermore, the coiling may leave unused paint at the bottom of the container. Lastly, because many hoses are not carefully engineered, impediments may enter the sprayer and further disrupt the application of the paint.

Thus, the need exists for a spray kit that retains paint, ensures continuous paint flow, maximizes the use of paint, and filters paint prior to its arrival at the spray device.

### BRIEF SUMMARY OF THE INVENTION

In light of the foregoing, it is a first aspect of the present invention to provide a spray kit with a conduit assembly.

It is another aspect of the present invention to provide a spray kit comprising a container having an aperture, a hose that passes through the aperture, a conduit assembly residing at least in part in the container, where at least a portion of the hose is received in the conduit assembly, and a spray device that fluidly communicates with the container via the hose.

It is still another aspect of the invention to provide a spray kit comprising a lid with an aperture, a reservoir adapted to receive the lid, a hose that passes through the aperture, a conduit assembly residing at least in part in the reservoir, where at least a portion of the hose resides in the conduit assembly, and a spray device that fluidly communicates with the container via the hose.

Yet another aspect of the present invention is a method of dispensing a fluid. This method includes the acts of putting fluid in a container, providing a conduit assembly for the container, providing a hose for the container wherein the hose at least partially resides in the conduit assembly, activating a spray device that is in fluid communication with the hose, thereby dispensing the fluid.

### BRIEF DESCRIPTION OF THE DRAWINGS

For a complete understanding of the objects, techniques and structure of the invention, reference should be made to the following detailed description and accompanying drawings, wherein:

FIG. 1 is an elevational view of a spray kit according to the concepts of the present invention;

FIG. 2 is a cross-sectional perspective view taken along lines 2-2 of FIG. 1 of the spray kit which has a container and a conduit assembly;

FIG. 3 is a cross-sectional perspective view of a modified lid, which carries the conduit assembly and which is received by the container, wherein the container and the conduit assembly are shown partially broken away;

FIG. 4A is a cross-sectional view of a filter arrangement included in the present invention; and

FIG. 4B is a cross-sectional view of an alternative filter arrangement included in the present invention.

### DETAILED DESCRIPTION

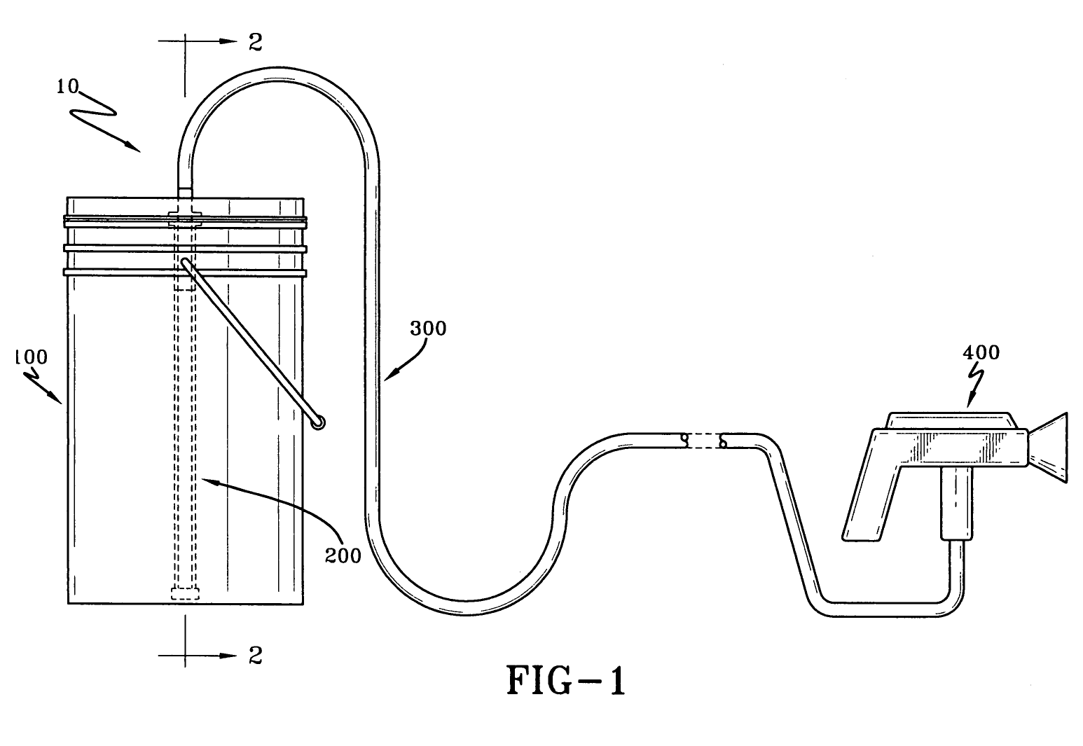

Referring now to the drawings, and in particular to FIG. 1, it can be seen that spray kit is designated generally by the numeral 10. Generally, the spray kit 10 includes a container 100 having an open end; a conduit assembly 200 that is located substantially inside the container 100; a hose 300 that is in fluid communication with the container 100 and is receivable in the conduit assembly 200; and a spray device 400 that is in fluid communication with the hose 300.

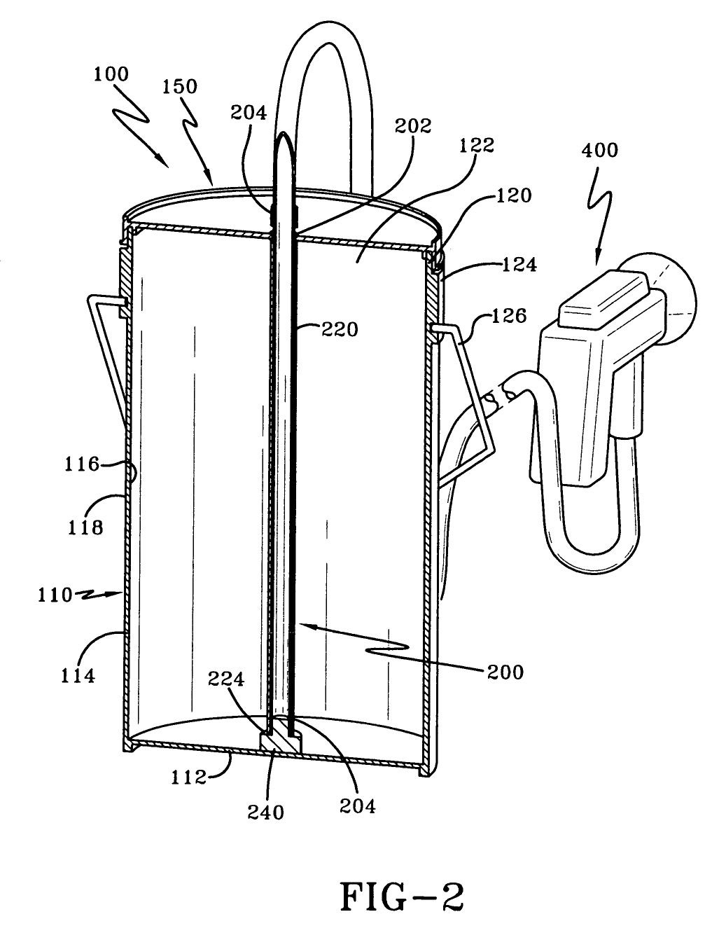

The container 100 may be any device that retains fluid or other material that can be pumped or otherwise dispensed by force. The container 100 generally includes an open end that receives the fluid and that allows the fluid to be dispensed. As shown in FIG. 2, the container 100 may include a reservoir 110 that receives a lid 150. The reservoir 110 and the lid 150 are generally designed to mate with one another such that the lid 150 is retained and not easily dislodged.

The reservoir 110 includes a bottom surface 112 that may be of any size or shape. For example, the bottom surface 112 may have a circular, square, rectangular, octagonal or any other shape. Typically, the bottom surface 112 is a round, planar surface. The reservoir 110 also includes one or more sidewalls 114 that adjoin the bottom surface 112 and extend therefrom. The sidewall 114 may be cylindrical. The sidewall 114 has an inner surface 116 and an outer surface 118. An end of the sidewall 114 opposite the bottom surface 118 terminates at a flange 120. An inner surface of the flange may seamlessly coalesce into the sidewall's inner surface 116. The flange 120 matches the sidewall 114 and is cylindrical in the illustrated embodiment. The reservoir 110, and in particular the flange 120, define a substantially open end 122 that is opposite the bottom surface 112. In addition to the above described elements, one or more rims 124 may extend from sidewall's outer surface 118. A handle 126 may also pivotably extend from the sidewall's outer surface 118.

In a particular embodiment, the reservoir 110 is made of plastic. However, the reservoir or portions thereof may be made of any other suitable material, including but not limited to: metal, rubber, paper, cardboard, glass, or fabric.

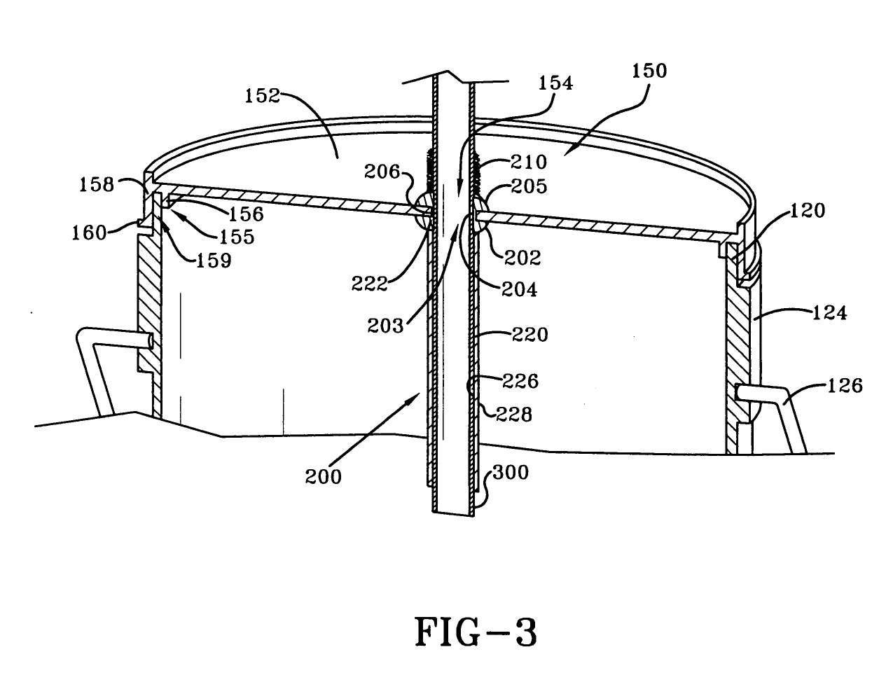

As shown in FIGS. 2 and 3, the container 100 may include a lid 150. The lid 150 is generally designed to engage the reservoir 110. The lid 150 includes a plate 152 which is typically a planar, disc-shaped member. Extending through the plate 152 is an aperture 154. Although shown centrally disposed, the aperture 154 may be located off-center in the lid.

An attachment flange 155 is located along the outer periphery of the plate 152. The attachment flange 155 is mateable with the reservoir 110, and in particular, the flange 120. The attachment flange 155 includes an inner collar 156 extending substantially perpendicularly downwardly from an interior underside of the plate 152. The attachment flange 155 may also include an outer collar 158 that extends substantially perpendicularly from the plate and is spaced radially outwardly from the inner collar. In other words, the inner collar 156 and the outer collar 158 are concentric and cylindrical, although one collar may differ in height from the other collar. Designed to receive the container's flange 120, the inner collar 156 and the outer collar 158 define a recess 159 therebetween. As shown, the inner collar 156 may extend from an underside of the plate 150. The outer collar 158 may extend both above and below the plate 152. In a particular embodiment, the outer collar 158 may be greater in length than the inner collar 156. Furthermore, a ledge 160 may extend radially outwardly from the outer collar 158. When the lid 150 is coupled to the reservoir 110, a recess may exist between the ledge 160 and the reservoir's rim 124.

In a particular embodiment, the lid 150 is made of plastic. However, the lid or portions thereof may be made of any other suitable material, including but not limited to: metal, rubber, paper, cardboard, glass, or fabric.

As shown in FIGS. 1-3, the conduit assembly 200 may be coupled to the container and in particular to the lid 150. The conduit assembly may include a seal 202, lubricant 210, a conduit tube 220, and a filter 240.

Generally, the seal 202 is designed to engage the container 100. The seal 202 has an aperture 203 therethrough that slidably receives the hose 300. In particular, the seal 202 is a disc-shaped member with an inner surface 204 that defines the central aperture 203 and an outer surface 205 that engages the lid 150. The perimeter of the seal's inner surface is sized to allow the hose's outer diameter or surface to slidably pass through the seal 202. The outer surface of the seal is configured to fit into the container's aperture. Indeed, the outer surface 205 of the seal may have an annular groove 206 that receives a portion of the container and, in particular, a portion of the lid's plate 152.

The conduit assembly 200 may also include a lubricant 210. This lubricant 210 may be applied to the outer surface of the hose 300. In one embodiment, the lubricant 210 may be applied on the outer surface of the hose 300 which is movable into the container 100. In other embodiments, the lubricant 210 may be applied to any portion or all of the hose. The lubricant may be oil, other petroleum-based products, or any similar lubricant known such as petroleum jelly.

The conduit assembly 200 may also include a conduit tube 220. The conduit tube 220 extends downward into the container 100. The conduit tube generally has a seal end 222 opposite a filter end 224. The seal end 222 may attach to the seal 202 by a friction fit or adhesive. Of course, other ways of fastening could be used to secure the seal 202 to the tube 220, such as mating threads or interlocking tabs and receptacles. The filter end 224 of the conduit tube 220 may contact a filter 240 (see FIG. 2). The conduit tube 220 provides an inner surface 226 and an outer surface 228 which are joined at the ends 222, 224. The perimeter of the conduit tube's inner surface 226 may be slightly larger than the outer perimeter of the hose. Thus, the hose 300 can pass through and slidably move within the conduit tube 220. In a particular embodiment, the conduit tube 220 is made of a semi-rigid material, such as plastic. Ideally, the conduit tube 220 is less flexible than the hose received therein. This prevents the hose from coiling within the container which would interfere with the fluid drawn through the hose by the spray device 400. As such, the spray hose 300 telescopically moves within the conduit tube 220.

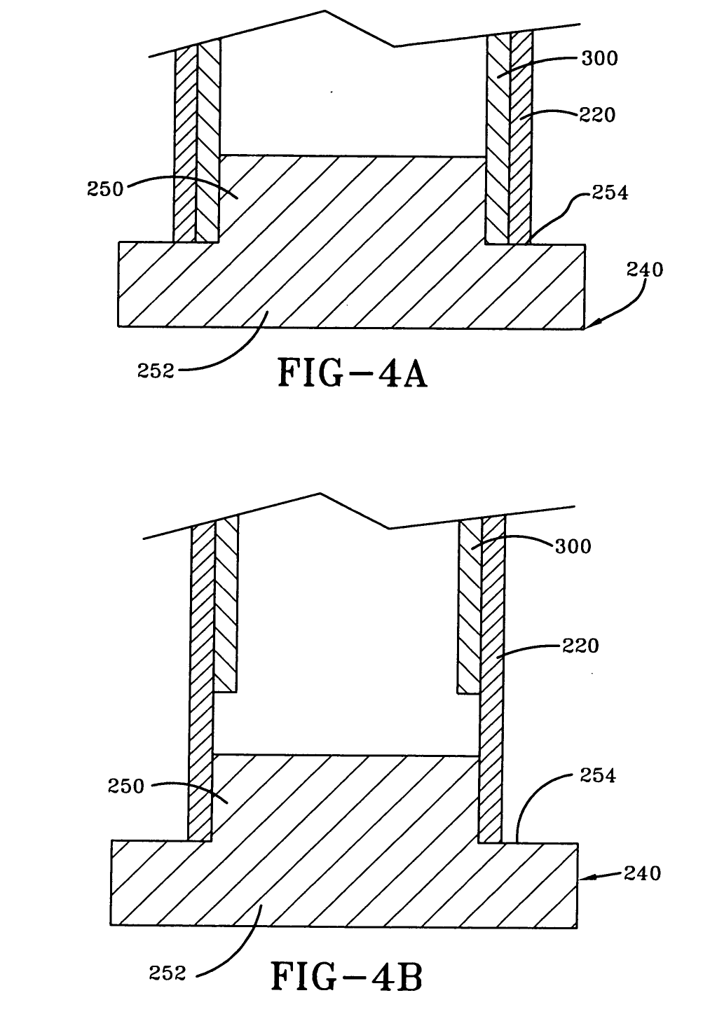

Referring now to FIG. 2, FIG. 4A and FIG. 4B; the conduit assembly 200 may also include a filter 240. Filter 240 may filter particulate matter from the fluid before the fluid is dispensed. The filter 240 is positioned inside the container 100 and may be of any size or shape. The filter may be constructed of any porous material that allows adequate fluid flow. The filter may be replaced as needed. Variations of the filter may have one or more regions that each have different perimeter. Regarding this type of multiple-region design, two illustrative embodiments are shown in FIG. 4A and FIG. 4B. As shown in those FIGS., the filter 240 may have a first region 250 and a second region 252. The first region 250 may have a smaller perimeter than the second region 252.

FIG. 4A illustrates a particular embodiment where the perimeter of the first region 250 is slightly less than the inner perimeter of hose 300. In this embodiment, friction between the outer perimeter of the first region 250 and the inner surface of the hose 300 causes the filter 240 to “stick,” or be retained, in the hose 300. The perimeter of the second region 252 may be larger than the perimeter of the first region 250, resulting in a step 254 that may have a length proportional to the difference between the first region's perimeter and the second region's perimeter. In particular, the step's length is greater than the combined thickness of the hose 300 and the conduit tube 220. Thus, the hose 300 and the conduit tube 220 may rest on the step 254. And it will be appreciated that the filter 240 may anchor the hose 300 near the bottom of the conduit tube 220.

FIG. 4B illustrates another embodiment. In this particular embodiment, the first region's perimeter is slightly less then the conduit tube's inner perimeter, but the first region's perimeter is greater than the hose's inner perimeter. As such, friction between the outer perimeter of the first region 250 and the inner surface of the conduit tube 220 cause the filter 240 to “stick,” or otherwise be retained, in the conduit tube 220. Unlike the previously described embodiment, however, the filter 240 in the present embodiment does not anchor the hose 300 near the bottom of the conduit tube. Thus, in this embodiment, the hose 300 may slide in the conduit tube 220 to the extent that friction allows.

In other embodiments, the filter 240 is not located near the bottom of the conduit tube 220, but rather the filter 240 may be located in another portion of the hose 300. For example, the filter may be positioned in the end of the hose nearest to the spray device 400, or may be positioned in a more central portion of the hose.

The filter 240 may be generally composed of any porous material. Various embodiments of the filter 240 may have different porosities. For example, one embodiment may include a filter that includes a layer of screening, while other embodiments may include a filter that is made of mesh or a sponge-like material.

In assembling various embodiments of the present concept, a person may pass the hose 300 through the lid 150 and the conduit assembly 200. Next, the user may secure the filter 240 to the hose and/or the conduit assembly 200. Lastly, the lid 150 and conduit assembly 200 may be attached to the reservoir 110.

Upon activating the spray device 400, fluid is drawn from the container 100, through the conduit assembly 200 and hose 300, and is expelled from the spray device 400. Ideally, the fluid flow will be continuous and result in uniform dispersion of the fluid.

Because the hose 300 is retained at least in part in the container 100, the hose 300 will not fall out. Thus, fluid spills will be minimized—saving the user the time costs associated with cleanup. In addition, the conduit assembly 200 prevents the hose 300 from coiling while inside the container 100. By reducing coiling, the conduit assembly 200 further aids in providing uniform fluid dispersion and minimizes unused fluid at the bottom of the container. Lastly, in embodiments that utilize a filter 240, the spray kit prevents impediments from entering the spray device 400, thereby aiding in uniform fluid dispersion.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto and thereby. Accordingly, for an appreciation of the true scope and breadth of the invention, reference should be made to the following claims.

What is claimed is:

1. A spray kit comprising:
a container having an aperture;
a hose that passes through the aperture;
a conduit assembly residing at least in part in the container, where at least a portion of the hose is received in the conduit assembly; and
a spray device that fluidly communicates with the container via the hose.

2. The spray kit according to claim 1, wherein the conduit assembly comprises:
a seal that resides at least partially in the aperture;
a conduit tube that contacts the seal and extends into the container;
wherein at least a portion of the hose is received in the conduit tube.

3. The spray kit according to claim 2, further comprising:
a lubricant disposed on an outer surface of the hose.

4. The spray kit according to claim 2, where the seal has a groove and where a surface of the container engages the groove.

5. The spray kit according to claim 2, further comprising:
a filter disposed at an end of the conduit tube.

6. The spray kit according to claim 5, wherein the filter has a first region with a first perimeter and a second region with a second perimeter, and wherein the first region fittingly engages the conduit tube.

7. The spray kit according to claim 5, wherein the filter has a first region with a first circumference and a second region with a second circumference, and wherein the first region fittingly engages the hose.

8. A spray kit comprising:
a lid with an aperture;
a reservoir adapted to receive the lid;
a hose that passes through the aperture;
a conduit assembly residing at least in part in the reservoir, where the conduit assembly houses at least a portion of the hose; and
a spray device that fluidly communicates with the reservoir via the hose.

9. The spray kit according to claim 8, wherein the lid is annularly shaped and comprises:
a plate having a first surface, a second surface, said aperture extending through said plate; and
an attachment flange disposed about an outer periphery of the plate.

10. The spray kit according to claim 9, wherein the attachment flange comprises:
an outer collar disposed about the outer periphery, wherein the outer collar extends from the first surface and the second surface;
an inner collar extending from the first surface; and
wherein the inner collar and the outer collar are separated by a recess that may receive a flange of the reservoir.

11. The spray kit according to claim 8, wherein the reservoir comprises:
a bottom surface;
a vertical wall that adjoins the bottom surface;
a substantially open end that is opposite the bottom surface; and
wherein the vertical wall terminates in a flange that is located near the substantially open end.

12. A method of dispensing a fluid, comprising the acts of:
putting fluid in a container;
providing a conduit assembly for the container;
providing a hose for the container, wherein the hose at least partially resides in the conduit assembly;
activating a spray device that is in fluid communication with the hose, thereby dispensing the fluid.

13. The method according to claim 12, further comprising the act of:
filtering the fluid as it enters the conduit assembly.

14. The method according to claim 12, further comprising the act of:
lubricating at least a portion of the hose.

15. The method according to claim 12, wherein the act of providing a conduit assembly includes providing a conduit assembly that comprises:
a seal that resides at least partially in an aperture in the container;
a conduit tube that contacts the seal and extends into the container;
wherein at least a portion of the hose resides in the conduit tube.
